(19) United States
(12) Patent Application Publication
(10) Pub. No.: US 2026/0237751 A1
(43) Pub. Date: Aug. 13, 2026

(54) ELECTRODE ASSEMBLY AND SECONDARY BATTERY COMPRISING THE SAME

(71) Applicants: Hyundai Motor Company, Seoul (KR); Kia Corporation, Seoul (KR)

(72) Inventors: Suchan Lee, Hwaseong-si (KR); Jihun Kim, Hwaseong-si (KR); Dongju Lee, Hwaseong-si (KR); Minhyun Jeong, Hwaseong-si (KR); Namgyu Kim, Hwaseong-si (KR); Sunghwan Kim, Hwaseong-si (KR); Youngwoo Lee, Hwaseong-si (KR); Jeongwan Yoo, Hwaseong-si (KR)

(21) Appl. No.: 19/252,805

(22) Filed: Jun. 27, 2025

(30) Foreign Application Priority Data
Feb. 13, 2025 (KR) 10-2025-0018410

(51) Int. Cl. H01M 10/0587; H01M 4/587; H01M 4/70

(52) U.S. Cl. CPC H01M 10/0587; H01M 4/587; H01M 4/70

(57) ABSTRACT

Provided is an electrode assembly formed by stacking a plurality of positive electrode portions and a plurality of negative electrode portions, including an outermost negative electrode portion. The outermost negative electrode portion includes a first negative electrode current collector having a first negative electrode active material layer on one surface and a second negative electrode active material layer on the opposite surface. One or both active material layers can include apertures or partially reduced coverage at an edge region, which may correspond to about 10-30% of the layer. Differences in composition or thickness between the layers help reduce volume expansion and bending stress, thereby enhancing performance and stability.

### CROSS-REFERENCE TO RELATED APPLICATION

This present application claims under 35 U.S.C. § 119(a) the benefit of Korean Patent Application No. 10-2025-0018410, filed on Feb. 13, 2025, in the Korean Intellectual Property Office, the entire disclosure of which is incorporated herein by reference.

### BACKGROUND

### Technical Field

The present disclosure relates to an electrode assembly and a secondary battery comprising the same.

### Background

In a jelly-roll type electrode assembly of a lithium secondary battery, a negative electrode is positioned at an outermost part of the jelly-roll to reduce lithium-ion deposition. The negative electrode disposed at the outermost part of the electrode assembly does not participate in electrochemical reactions because it does not face a positive electrode, while a negative electrode disposed inside the electrode assembly does participate in electrochemical reactions with a facing positive electrode. During repeated charging and discharging, stress arises from the volume difference between the outermost negative electrode and the inner negative electrode, potentially leading to stability issues such as electrode delamination and separator damage.

### SUMMARY

The present disclosure is directed to providing an electrode assembly capable of reducing volume change and a secondary battery comprising the same.

The present disclosure is directed to reducing a volume change due to asymmetry of an outermost electrode in an electrode assembly having a stacked jellyroll structure.

According to some embodiments of the present disclosure, an electrode assembly is provided, wherein a plurality of positive electrode and a plurality of negative electrode are stacked, wherein the negative electrode comprise an outermost negative electrode portion disposed at an outermost part of the electrode assembly, wherein the outermost negative electrode portion comprises a first negative electrode current collector, a first negative electrode active material layer disposed on one surface of the first negative electrode current collector, and a second negative electrode active material layer disposed on the other surface of the first negative electrode current collector, wherein one or more of the first negative electrode current collector, the first negative electrode active material layer, or the second negative electrode active material layer may have at least one aperture.

In the electrode assembly according to some embodiments, the first negative electrode active material layer and the second negative electrode active material layer may have different patterns.

In the electrode assembly according to some embodiments, the first negative electrode active material layer may be disposed at the outermost part of the electrode assembly, the second negative electrode active material layer may be disposed to face a positive electrode portion, and the second negative electrode active material layer may comprise at least one aperture.

In the electrode assembly according to some embodiments, the second negative electrode active material layer may comprise at least one aperture, wherein the depth of the at least one aperture may be less than a thickness of the second negative electrode active material layer.

In the electrode assembly according to some embodiments, the second negative electrode active material layer may comprise at least one aperture, wherein a depth of the aperture may be equal to the thickness of the second negative electrode active material layer.

In the electrode assembly according to some embodiments, the first negative electrode current collector and the second negative electrode active material layer may each comprise at least one aperture.

In the electrode assembly according to some embodiments, the first negative electrode current collector, the first negative electrode active material layer, and the second negative electrode active material layer may each comprise at least one aperture.

In the electrode assembly according to some embodiments, an aperture ratio of the at least one aperture may satisfy Equation 1.

$$Maximum aperture ratio = 1 - \frac{1}{N / P ratio} \qquad [ Equation l ]$$

In the electrode assembly according to some embodiments, the second negative electrode active material layer may comprise an edge region corresponding to 10 to 30% of a total area of the second negative electrode active material, wherein an aperture ratio of the edge region may be higher than an aperture ratio of a region other than the edge region.

In the electrode assembly according to some embodiments, the first negative electrode active material layer and the second negative electrode active material layer may comprise different negative electrode active materials.

In the electrode assembly according to some embodiments, the first negative electrode active material layer and the second negative electrode active material layer may comprise graphite and silicon as negative electrode active materials, wherein a mixing ratio of graphite and silicon in the first negative electrode active material layer may be different from a mixing ratio of graphite and silicon in the second negative electrode active material layer.

In the electrode assembly according to some embodiments, a proportion of graphite in the first negative electrode active material layer may be higher than a proportion of graphite in the second negative electrode active material layer.

In the electrode assembly according to some embodiments, the electrode assembly may be in a jelly-roll shape.

A secondary battery according to some embodiments of the present disclosure may comprise the electrode assembly.

Also provided is an electrode assembly comprising a plurality of positive electrodes and a plurality of negative electrodes that are stacked, wherein the negative electrodes comprise an outermost negative electrode portion disposed at an outermost part of the electrode assembly, the outermost negative electrode portion comprising: a first negative electrode current collector; a first negative electrode active material layer disposed on one surface of the first negative electrode current collector; and a second negative electrode active material layer disposed on the other surface of the first negative electrode current collector, wherein the second negative electrode active material layer is formed to partially cover the first negative electrode current collector, such that an uncovered region of the first negative electrode current collector extends along an edge portion of the outermost negative electrode portion,

The uncovered region in the portion may correspond to about 10 to 30% of a total area of the second negative electrode active material.

The second negative electrode active material layer may include a plurality of apertures having an aperture ratio of the at least one aperture satisfies Equation 1

$$Maximum aperture ratio = 1 - \frac{1}{N / P ratio} \qquad [ Equation l ]$$

wherein the N/P ratio refers to a negative-electrode loading relative to a positive-electrode loading.

The uncovered region of the first negative electrode current collector at the edge portion may be configured such that, during winding or folding of the electrode assembly into a jelly-roll or z-folded structure, localized stress concentrations at the outermost region of the electrode assembly are mitigated.

The second negative electrode active material layer may have an overall thickness that is less than the thickness of the first negative electrode active material layer.

The first negative electrode active material layer and the second negative electrode active material layer may comprise different patterns.

The electrode assembly and secondary battery according to some embodiments of the present disclosure may reduce volume changes.

The electrode assembly and secondary battery according to some embodiments of the present disclosure may reduce volume changes due to asymmetry of the outermost electrode in a stacked jelly-roll structure.

The electrode assembly and secondary battery according to some embodiments of the present disclosure may reduce asymmetric volume changes and reduce bending stress that may occur during charging and discharging, thereby preventing issues related to battery stability such as electrode delamination and separator damage.

The effects of the present disclosure are not limited to those mentioned above, and other effects not mentioned can be clearly understood by those skilled in the art from the following description.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a perspective view of an electrode assembly according to some embodiments of the present disclosure.

FIG. 2 is a cross-sectional view of region A in FIG. 1.

FIG. 3 is a cross-sectional view illustrating an outermost negative electrode portion included in the electrode assembly.

FIG. 4 is a cross-sectional view of the outermost negative electrode portion, showing apertures formed in a negative electrode active material layer.

FIG. 5 is a cross-sectional view illustrating separate negative electrode active material layers on opposing surfaces of a single negative electrode current collector.

FIG. 6 is a cross-sectional view depicting another embodiment of the outermost negative electrode portion with apertures of varying depth.

FIG. 7 is a cross-sectional view showing a negative electrode active material layer configured with an aperture ratio to reduce lithium deposition.

FIG. 8 is a top view of the outermost negative electrode portion, highlighting an edge region having a higher aperture ratio than a central region.

FIG. 9 is a top view illustrating multiple regions of the negative electrode active material layer, each featuring a distinct aperture pattern.

### DETAILED DESCRIPTION

Embodiments described in the present specification can be modified into various other forms, and the technology according to exemplary embodiments is not limited to the embodiments described below. The exemplary embodiments are provided to make the description of the present disclosure thorough and to fully convey the scope of the present disclosure to those skilled in the art.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMS, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In addition, numerical ranges used in this specification include all values between the lower and upper limits, all values incrementally derived logically within shape and breadth of the defined ranges, all double-limited values, and all possible combinations of upper and lower limits of differently limited numerical ranges. Unless specifically defined in this specification, values outside the defined numerical ranges that may occur due to experimental error or rounding off of values are also included within the defined numerical ranges.

Furthermore, terms including ordinals such as first, second, etc. may be used to describe various elements, but the elements are not limited by these terms. These terms are only used to distinguish one constituent element from another.

The term “outermost negative electrode portion” herein refers to a negative electrode structure positioned at the most external region of a stacked or wound electrode assembly, such that it does not directly face a positive electrode during electrochemical reactions.

The term “aperture” herein refers to an opening, hole, or recess formed in at least a portion of an electrode active material layer or current collector.

Embodiments of the present disclosure may provide an electrode assembly and a secondary battery comprising the same that are capable of reducing volume changes. The electrode assembly and secondary battery comprising the same according to embodiments of the present disclosure may reduce volume changes due to asymmetry of an outermost electrode in a stacked jelly-roll structure electrode assembly.

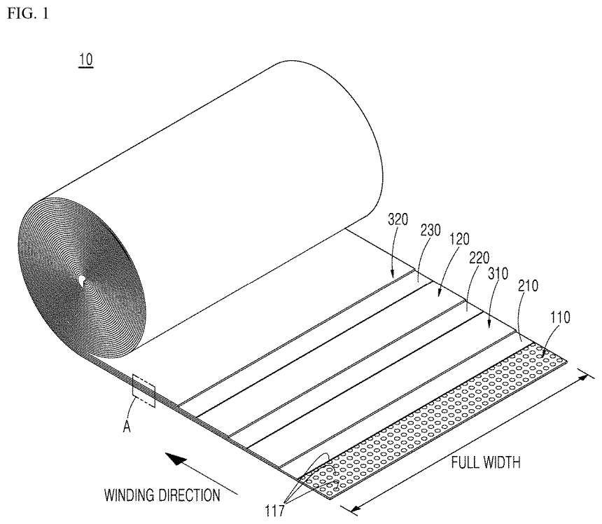

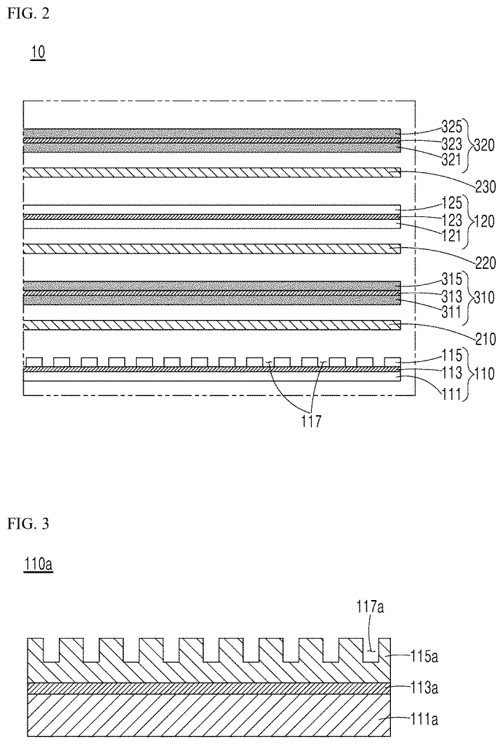

FIG. 1 is a perspective view of an electrode assembly according to some embodiments of the present disclosure. FIG. 2 is a cross-sectional view of region A in FIG. 1.

Referring to FIGS. 1 and 2, the electrode assembly according to some embodiments of the present disclosure may be in a stacked jelly-roll structure. The figures show a jelly-roll structure adopting a winding method, but the embodiments are not limited thereto, and the electrode assembly may also be in a jelly-roll structure adopting a Z-folding method.

The electrode assembly (10) may comprise positive electrode portions (310, 320) and negative electrode portions (110, 120). The positive electrode portions (310, 320) and the negative electrode portions (110, 120) may be repeatedly disposed alternately. Separators (210, 220, 230) may be disposed between the positive electrode portions (310, 320) and the negative electrode portions (110, 120).

Referring to FIG. 2, the positive electrode portions (310, 320) may comprise a first positive electrode portion (310) and a second positive electrode portion (320).

The first positive electrode portion (310) may comprise a first positive electrode current collector (313), and first positive electrode active material layers (311, 315) disposed on respective surfaces of the first positive electrode current collector (313).

The second positive electrode portion (320) may comprise a second positive electrode current collector (323), and second positive electrode active material layers (321, 325) disposed on respective surfaces of the second positive electrode current collector (323).

The first positive electrode current collector (313) and the second positive electrode current collector (323) may comprise various materials that have conductivity without causing chemical changes in the battery. For example, the first positive electrode current collector (313) and the second positive electrode current collector (323) may be stainless steel, aluminum, nickel, titanium, baked carbon, or aluminum or stainless-steel surface-treated with carbon, nickel, titanium, silver, etc. That is, the first positive electrode current collector (313) and the second positive electrode current collector (323) may comprise forms such as surface-treated stainless steel, aluminum foil, etc.

The first positive electrode current collector (313) and the second positive electrode current collector (323) may typically have a thickness of 3 to 50 μm and may also form fine irregularities on the surface to increase the adhesion of the positive electrode active material layer. For example, the first positive electrode current collector (313) and the second positive electrode current collector (323) may be used in various forms such as films, sheets, foils, nets, porous bodies, foams, non-woven fabrics, etc.

The first positive electrode active material layers (311, 315) and the second positive electrode active material layers (321, 325) may comprise a positive electrode active material, a conductive material, and a binder.

The positive electrode active material may be various materials among commonly used positive electrode active materials. For example, the positive electrode active material may comprise one or more of nickel cobalt manganese (NCM), nickel cobalt aluminum (NCA), lithium manganese oxide (LMO), lithium cobalt oxide (LCO), lithium iron phosphate (LFP), or any combination thereof, but is not limited thereto.

The conductive material is used to provide conductivity to the electrode and may comprise various materials that have electronic conductivity without causing chemical changes in the battery. For example, the conductive material may comprise one or more of natural graphite, artificial graphite, carbon black, acetylene black, ketjenblack, channel black, furnace black, lamp black, thermal black, conductive fibers, fluorocarbon, aluminum powder, nickel powder, zinc oxide, potassium titanate, titanium oxide, polyphenylene derivatives, carbon nanotubes, flake graphite, graphene, graphene oxide, graphite flakes, or any combination thereof.

The binder may improve adhesion between positive electrode active material particles and adhesion between the positive electrode active material and the positive electrode current collector. For example, the binder may comprise one or more of polyvinylidene fluoride-hexafluoropropylene copolymer (PVDF-co-HFP), polyvinylidene fluoride, polyacrylonitrile, polymethylmethacrylate, polyvinyl alcohol, carboxymethylcellulose (CMC), starch, hydroxypropylcellulose, regenerated cellulose, polyvinylpyrrolidone, tetrafluoroethylene, polyethylene, polypropylene, polyacrylic acid, ethylene-propylene-diene monomer (EPDM), sulfonated EPDM, styrene butadiene rubber (SBR), fluoro rubber, poly acrylic acid, or any combination thereof and the binder may also comprise various copolymers of these.

The negative electrode portions (110, 120) may comprise an outermost negative electrode portion (110) disposed at the outermost part of the electrode assembly (10) and an inner negative electrode portion (120) disposed at a part that is not the outermost part of the electrode assembly (10).

The outermost negative electrode portion (110) may comprise a first negative electrode current collector (113), a first negative electrode active material layer (111) disposed on one surface of the first negative electrode current collector (113), and a second negative electrode active material layer (115) disposed on the other surface of the first negative electrode current collector (113).

The first negative electrode active material layer (111) may be disposed at the outermost part of the electrode assembly (10). The first negative electrode active material layer (111) may be a layer that does not participate in electrochemical reactions because there is no positive electrode portion facing it.

The second negative electrode active material layer (115) may be disposed to face the first positive electrode portion (310). The second negative electrode active material layer (115) may be a layer that faces any one of the first positive electrode active material layers (311, 315) of the first positive electrode portion (310), and thus participates in electrochemical reactions.

One or more of the first negative electrode current collector (113), the first negative electrode active material layer (111), or the second negative electrode active material layer (115) may have at least one aperture. For example, the second negative electrode active material layer (115) may have apertures (117). The apertures (117) may be holes or recesses formed in the direction of the first negative electrode current collector (113) from the second negative electrode active material layer (115).

The apertures (117) may be arranged in various shapes and sizes in the second negative electrode active material layer (115). For example, the apertures (117) may be in various shapes such as circular, triangular, square, hexagonal, polygonal, etc. when viewed from above.

When the processing ratio of the aperture (117) in the second negative electrode active material layer (115) is X %, the total volume (V) of the second negative electrode active material layer (115) and the volume change (ΔV) during charging and discharging may be reduced by X %. Accordingly, stress acting on the outermost negative electrode portion (110) may also be reduced by X %.

By reducing stress through the processing of the aperture (117), the stability and expected life of the secondary battery may be improved. In addition, by preventing localized stress concentration, the stress acting on the electrode assembly (10) may be reduced.

The maximum aperture ratio of the apertures (117) may vary depending on the N/P ratio of the electrode assembly. “N/P ratio” refers to the percentage of negative electrode loading relative to positive electrode loading, that is, (negative electrode loading/positive electrode loading)×100.

If the N/P ratio after processing the apertures (117) becomes less than 1, there may be a risk of lithium deposition, so the maximum aperture ratio may be determined according to Equation 1.

$$Maximum aperture ratio = 1 - \frac{1}{N / P ratio} \qquad [ Equation l ]$$

The apertures (117) may buffer the volume change between the first negative electrode active material layer (111) that does not participate in electrochemical reactions and the second negative electrode active material layer (115) that does participate in electrochemical reactions. During charging and discharging of the battery, the first negative electrode active material layer (111) that does not participate in electrochemical reactions does not undergo volume changes, while the second negative electrode active material layer (115) that does participate in electrochemical reactions may increase in volume. The apertures (117) may reduce the asymmetric volume change of the first negative electrode active material layer (111) and the second negative electrode active material layer (115). The apertures (117) may reduce the bending stress that may occur during the charging and discharging of the outermost negative electrode portion (110). The aperture (117) may prevent issues related to battery stability such as electrode delamination and separator damage.

The inner negative electrode portion (120) may comprise a second negative electrode current collector (123), and third negative electrode active material layers (121, 125) disposed on respective surfaces of the second negative electrode current collector (123).

The first negative electrode current collector (113) and the second negative electrode current collector (123) may comprise various materials that have conductivity without causing chemical changes in the battery. For example, the first negative electrode current collector (113) and the second negative electrode current collector (123) may be copper, stainless steel, aluminum, nickel, titanium, baked carbon, or aluminum or stainless-steel surface-treated with carbon, nickel, titanium, silver, etc. Fine irregularities may also be formed on the surface of the first negative electrode current collector (113) and the second negative electrode current collector (123) to strengthen the binding of the negative electrode active material.

The thickness of each of the first negative electrode current collector (113) and the second negative electrode current collector (123) may be 3 μm or more and 500 μm or less, but the thickness is not limited thereto.

The third negative electrode active material layers (121, 125) may comprise a negative electrode active material, a conductive material, and a binder.

The negative electrode active material may comprise a compound capable of reversible intercalation and deintercalation of lithium. Examples may include: carbonaceous materials such as artificial graphite, natural graphite, graphitized carbon fiber, and amorphous carbon; metallic compounds capable of alloying with lithium such as Si, Al, Sn, Pb, Zn, Bi, In, Mg, Ga, Cd, Si alloy, and Sn alloy or Al alloy; metal oxides capable of doping and dedoping lithium such as SiOv (0<v<2), SnO2, vanadium oxide, and lithium vanadium oxide; and composites comprising the above metallic compounds and carbonaceous materials such as Si—C composites or Sn—C composites, and one or more mixtures of these may be used. In addition, a metal lithium film may be used as the negative electrode active material. The carbonaceous materials may include both low-crystalline carbon and high-crystalline carbon. Representative examples of low-crystalline carbons include soft carbon and hard carbon, and typical high-crystalline carbons include amorphous, plate-like, flaky, spherical, or fiber-type natural graphite or artificial graphite, Kish graphite, pyrolytic carbon, mesophase pitch-based carbon fiber, meso-carbon microbeads, mesophase pitches, and high-temperature baked carbons such as petroleum or coal tar pitch derived cokes.

The conductive material and binder may be the same as the conductive material and binder included in the positive electrode active material layer described above.

The electrode assembly (10) may be formed by stacking positive electrode portions (310, 320) and negative electrode portions (110, 120). Although the drawing shows the positive electrode portions (310, 320) and the negative electrode portions (110, 120) each comprising two portions, embodiments are not limited to this, and they may be stacked in multiple layers.

Hereinafter, referring to FIG. 3, the outermost negative electrode portion included in the electrode assembly according to various embodiments of the present disclosure will be described.

FIG. 3 is a cross-sectional view of an outermost negative electrode portion according to various embodiments of the present disclosure.

Referring to FIG. 3, an outermost negative electrode portion (110a) according to various embodiments of the present disclosure may comprise a first negative electrode current collector (113a), a first negative electrode active material layer (111a) disposed on one surface of the first negative electrode current collector (113a), and a second negative electrode active material layer (115a) disposed on the other surface of the first negative electrode current collector (113a).

The first negative electrode active material layer (111a) may be disposed at the outermost part of the electrode assembly (10). The first negative electrode active material layer (111a) may be a layer that does not participate in electrochemical reactions because there is no positive electrode portion facing the first negative electrode active material layer (111a).

The second negative electrode active material layer (115a) may be disposed to face a positive electrode portion. The second negative electrode active material layer (115a) may be a layer that faces the first positive electrode active material layer of the positive electrode portion and thus participates in electrochemical reactions.

The second negative electrode active material layer (115a) may include apertures (117a). Here, the apertures (117a) may be formed in a part of the second negative electrode active material layer (115a). The apertures (117a) may be formed by processing a part of the second negative electrode active material layer (115a). The depth of the apertures (117a) may be less than the thickness of the second negative electrode active material layer (115a). That is, the apertures (117a) may be formed so as not to expose the surface of the first negative electrode current collector (113a).

Considering that the bending stress increases as the distance from the first negative electrode current collector (113a) increases, the present embodiment may be effective in reducing the bending stress of the second negative electrode active material layer (115a). Meanwhile, to obtain the aperture ratio according to the above equation, a large number of apertures (117a) may be formed in the second negative electrode active material layer (115a).

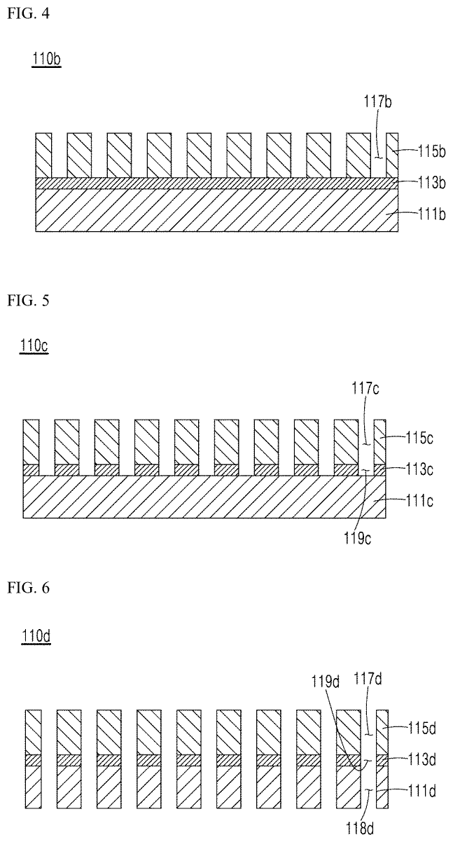

Hereinafter, referring to FIG. 4, the outermost negative electrode portion included in the electrode assembly according to various embodiments of the present disclosure will be described.

FIG. 4 is a cross-sectional view of the outermost negative electrode portion according to various embodiments of the present disclosure.

Referring to FIG. 4, an outermost negative electrode portion (110b) according to various embodiments of the present disclosure may comprise a first negative electrode current collector (113b), a first negative electrode active material layer (111b) disposed on one surface of the first negative electrode current collector (113b), and a second negative electrode active material layer (115b) disposed on the other surface of the first negative electrode current collector (113b).

The second negative electrode active material layer (115b) may comprise apertures (117b). Here, the depth of the apertures (117b) may be equal to the thickness of the second negative electrode active material layer (115b). That is, the apertures (117b) may be formed to expose the surface of the first negative electrode current collector (113b).

In the present embodiment, a stress concentration phenomenon can be alleviated across the entire outermost negative electrode portion (110b), and the stress between the second negative electrode active material layer (115b) and the first negative electrode current collector (113b) can also be reduced.

Hereinafter, referring to FIG. 5, the outermost negative electrode portion included in the electrode assembly according to various embodiments of the present disclosure will be described.

FIG. 5 is a cross-sectional view of the outermost negative electrode portion according to various embodiments of the present disclosure.

Referring to FIG. 5, an outermost negative electrode portion (110c) according to various embodiments of the present disclosure may comprise a first negative electrode current collector (113c), a first negative electrode active material layer (111c) disposed on one surface of the first negative electrode current collector (113c), and a second negative electrode active material layer (115c) disposed on the other surface of the first negative electrode current collector (113c).

The second negative electrode active material layer (115c) may comprise apertures (117c). Here, the depth of the apertures (117c) may be equal to the thickness of the second negative electrode active material layer (115c).

The first negative electrode current collector (113c) may include apertures (119c). Here, the depth of the apertures (119c) may be equal to the thickness of the first negative electrode current collector (113c). That is, the apertures (119c) may be formed to expose the surface of the first negative electrode active material layer (111c).

In this embodiment, by including the apertures (117c, 119c) that penetrate the second negative electrode active material layer (115c) and the first negative electrode current collector (113c), a part of the exposed surface of the first negative electrode active material layer (111c) can be used for charging and discharging. Therefore, it can be applied to electrode assembly designs where the N/P ratio is important.

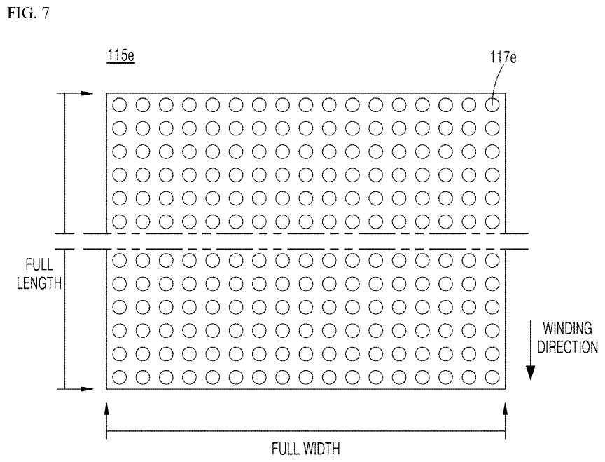

Hereinafter, referring to FIG. 6, the outermost negative electrode portion included in the electrode assembly according to various embodiments of the present disclosure will be described.

FIG. 6 is a cross-sectional view of an outermost negative electrode portion according to various embodiments of the present disclosure.

Referring to FIG. 6, an outermost negative electrode portion (110d) according to various embodiments of the present disclosure may comprise a first negative electrode current collector (113d), a first negative electrode active material layer (111d) disposed on one surface of the first negative electrode current collector (113d), and a second negative electrode active material layer (115d) disposed on the other surface of the first negative electrode current collector (113d).

The second negative electrode active material layer (115d) may comprise apertures (117d). Here, the depth of the apertures (117d) may be equal to the thickness of the second negative electrode active material layer (115d).

The first negative electrode current collector (113d) may include apertures (119d). Here, the depth of the apertures (119d) may be equal to the thickness of the first negative electrode current collector (113d).

The first negative electrode active material layer (111d) may include apertures (118d). Here, the depth of the apertures (118d) may be equal to the thickness of the first negative electrode active material layer (111d).

In the present embodiment, by including the apertures (117d, 119d, 118d) that penetrate the second negative electrode active material layer (115d), the first negative electrode current collector (113d), and the first negative electrode active material layer (111d), processing may be facilitated and advantageous in terms of electrode output.

Hereinafter, referring to FIG. 7, the outermost negative electrode portion included in the electrode assembly according to various embodiments of the present disclosure will be described.

FIG. 7 is a top view of an outermost negative electrode portion according to various embodiments of the present disclosure.

Referring to FIG. 7, a second negative electrode active material layer (115e) may comprise apertures (117e). The apertures (117e) may have the same size, pattern, and area along the full width and full-length directions. Therefore, the stress concentration phenomena that may occur in the outermost negative electrode portion can be prevented, and stress can be uniformly reduced.

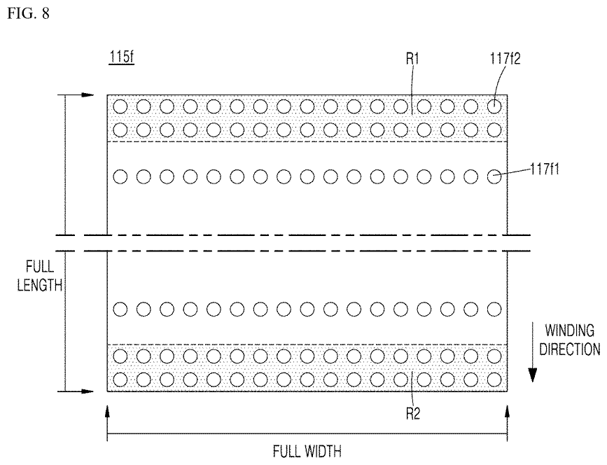

FIG. 8 is a top view of an outermost negative electrode portion according to various embodiments of the present disclosure.

Referring to FIG. 8, a first region (R1) and a second region (R2) may be defined along a full width direction of an edge region of a second negative electrode active material layer (115f). The first region (R1) and the second region (R2) may be two regions located respectively at one end of the second negative electrode active material layer (115f) and the other end of the second negative electrode active material layer (115f) facing the one end. The first region (R1) and the second region (R2) may have an area corresponding to 10 to 30% of the total area of the second negative electrode active material layer (115f). The first region (R1) at the one end of the second negative electrode active material layer (115f) and the second region (R2) at the other end of the second negative electrode active material layer (115f) may each have an area corresponding to 5 to 15% of the total area of the second negative electrode active material layer (115f). Through the area within this range, the stress concentration relief effect of the entire electrode may be significantly enhanced, and side effects such as stiffness reduction and stress increase may be prevented.

The first region (R1) and the second region (R2) may include first apertures (117f2). Meanwhile, the region other than the first region (R1) and the second region (R2) may include second apertures (117f1).

The aperture ratio of the first region (R1) and the second region (R2) may be higher than the aperture ratio of the region other than the first region (R1) and the second region (R2). Therefore, the aperture ratio may be adjusted by varying the size, pattern, or density of the first apertures (117f2) and the second apertures (117f1). Meanwhile, the maximum aperture ratio of the first region (R1) and the second region (R2) may be set to satisfy Equation 1 recited above.

Electrode material delamination and contact between the separator and the electrode edge, etc., mainly occur at the edge portion of the electrode. Therefore, in the present embodiment, by making the aperture ratio of the first region (R1) and the second region (R2) higher, electrode material delamination and contact between the separator and the electrode edge, etc., may be prevented, and battery stability may be increased. In addition, patterning processes such as roll-to-roll for aperture formation may be facilitated.

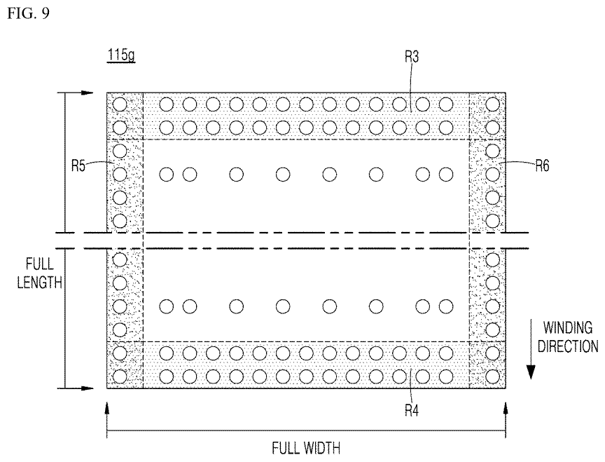

FIG. 9 is a top view of an outermost negative electrode portion according to various embodiments of the present disclosure.

Referring to FIG. 9, a third region (R3) and a fourth region (R4) may be defined along the full width direction of an edge region of a second negative electrode active material layer (115g). A fifth region (R5) and a sixth region (R6) may be defined along the full-length direction of the edge region of the second negative electrode active material layer (115g).

The third region (R3), the fourth region (R4), the fifth region (R5), and the sixth region (R6) may have an area corresponding to 10 to 30% of the total area of the second negative electrode active material layer (115f). Through the area within this range, the stress concentration relief effect of the entire electrode may be significantly enhanced, and side effects such as stiffness reduction and stress increase may be prevented.

The aperture ratio of the third region (R3), the fourth region (R4), the fifth region (R5), and the sixth region (R6) may be higher than the aperture ratio of the region other than the third region (R3), the fourth region (R4), the fifth region (R5), and the sixth region (R6). The aperture ratio of the third region (R3) and the fourth region (R4) may be higher than the aperture ratio of the fifth region (R5) and the sixth region (R6).

Accordingly, the aperture ratio may be adjusted by varying the size, pattern, or density of the apertures included in the third region (R3) and the fourth region (R4), the apertures included in the fifth region (R5) and the sixth region (R6), and the apertures included in the other regions. Meanwhile, the maximum aperture ratio of the third region (R3) and the fourth region (R4) may be set to satisfy Equation 1 recited above.

In the present embodiment, by making the aperture ratio of all edge regions of the second negative electrode active material layer (115g) higher, electrode material delamination and contact between the separator and the electrode edge, etc., may be prevented, and battery stability may be increased.

Meanwhile, to reduce the stress during the charging and discharging of the battery, apertures may be formed in the outermost negative electrode portion as described above, or as described below, the ratio of the negative electrode active materials may be adjusted.

For example, when graphite and silicon are mixed as negative electrode active materials, the mixing ratio of graphite and silicon in the first negative electrode active material layer that does not face the positive electrode portion and the second negative electrode active material layer that faces the positive electrode portion in the outermost negative electrode portion may be adjusted.

Graphite can be classified as a low capacity/low expansion material, and silicon as a high capacity/high expansion material, and the capacity and expansion rate of the negative electrode are determined by the combination ratio of graphite and silicon. The proportion of graphite in the first negative electrode active material layer may be higher compared to the proportion of graphite in the second negative electrode active material layer. That is, the proportion of silicon in the first negative electrode active material layer may be lower than the proportion of silicon in the second negative electrode active material layer. Accordingly, during charging and discharging, the ΔV of the first negative electrode active material layer may decrease, reducing the asymmetric volume change and stress in the outermost negative electrode portion.

As the proportion of graphite in the first negative electrode active material layer increases, the thickness increases, thereby having the effect of reducing bending stress. Meanwhile, the decrease in output due to the increase in thickness can be offset through the apertures.

The change in electrode characteristics according to the combination ratio of graphite and silicon can be formulated as follows:

$${C}_{total} = {C}_{graphite} \times w + {C}_{silicon} \times ( 1 - w )$$

Here, Cₜₒₜₐₗ is the total electrode capacity, C_{graphite} is the graphite capacity, C_{silicon} is the silicon capacity, and w is the proportion of graphite.

$${Δ V}_{total} = {Δ V}_{graphite} \times w + {Δ V}_{silicon} \times ( 1 - w )$$

Here, ΔVₜₒₜₐₗ is the volume change rate of the entire electrode, ΔV_{graphite} is the change in graphite volume, ΔV_{silicon} is the silicon volume change rate, and w is the proportion of graphite.

If the proportion of graphite before active material ratio adjustment is w1, and the electrode thickness at this time is t, t may satisfy the following equation:

$$t = \frac{{C}_{total}}{ρ A ( {w}_{1} {C}_{graphite} + ( 1 - {w}_{1} ) {C}_{silicon} )}$$

If the proportion of graphite after active material ratio adjustment is w2, and the electrode thickness at this time is h, h may satisfy the following equation:

$$h = \frac{{C}_{total}}{ρ A ( {w}_{2} {C}_{graphite} + ( 1 - {w}_{2} ) {C}_{silicon} )}$$

Accordingly, the thickness ratio (h/t) before and after adjusting the active material ratio is as follows:

$$\frac{h}{t} = \frac{( {w}_{1} {C}_{graphite} + ( 1 - {w}_{1} ) {C}_{silicon} )}{( {w}_{2} {C}_{graphite} + ( 1 - {w}_{2} ) {C}_{silicon} )}$$

The volume change reduction effect of negative electrode active material ratio adjustment was calculated assuming the properties of graphite/silicon that can be applied to a secondary battery negative electrode as shown in Table 1 below.

TABLE 1

| | Capacity (mAh/g) | Volume change rate |
|---|---|---|
| Graphite | 370 | 1.1 |
| Silicon | 1500 | 2 |

Assuming electrodes of the same capacity when adjusting the graphite/silicon ratio, the volume change rate and thickness ratio were calculated as shown in Table 2 below.

TABLE 2

| | Before ratio adjustment | After ratio adjustment |
|---|---|---|
| Negative electrode | Graphite 90%, silicon 10% | Graphite 100% |
| active material ratio | | |
| Thickness ratio h/t | 1.28 | |
| Volume change rate | 1.19 | 1.11 |

Meanwhile, the bending stress reduction effect is calculated as below.

The bending stress of the electrode before active material ratio adjustment is calculated by the following equation:

$$σ = A \frac{( {Δ V}_{1} ) T}{{( T + 2 t )}^{2}}$$

Here, σ is the bending stress before active material ratio adjustment, A is A=0.03ab²ρ (a=electrode long side length, b=electrode short side length, ρ=electrode density) assuming the electrode is an ideal rectangular parallelepiped, T is the current collector thickness, t is the electrode coating surface thickness before active material ratio adjustment, and ΔV₁ is the volume change rate of the electrode during charging before active material ratio adjustment.

The bending stress of the electrode after active material ratio adjustment is calculated by the following equation:

$${σ}^{′} = A \frac{( {Δ V}_{2} - X ) T}{{( T + 2 h )}^{2}}$$

Here, σ′ is the bending stress after active material ratio adjustment, A is the electrode property value (size, density, etc.) and other coefficients, T is the current collector thickness, h is the electrode coating surface thickness after active material ratio adjustment, ΔV₂ is the volume change rate of the electrode during charging after active material ratio adjustment, and X is the aperture ratio.

Accordingly, the bending stress change rate can be derived by the following equation:

$$Δσ = \frac{{( T + 2 t )}^{2}}{{( T + 2 h )}^{2}} \times ( \frac{{Δ V}_{2} - X}{{Δ V}_{1}} )$$

Hereinafter, the present disclosure will be described in more detail by means of examples. However, the following examples and experimental examples are provided merely to describe the present disclosure in more detail, and the scope of the present disclosure is not limited by the following examples and experimental examples.

### Example: Confirmation of Stress Reduction Effect

A first negative electrode active material layer with apertures was formed on one surface of a Cu foil current collector, and a second negative electrode active material layer without apertures was formed on the other surface.

The bending stress change rate was calculated for the negative electrode in Table 2 above. The factors here are as follows:

$$T ( current collector thickness ) = 8$$

$$t ( electrode thickness before active material ratio adjustment ) = 60$$

$$h ( electrode thickness after active material ratio adjustment ) = 60 \times 1.28 = 76.8$$

$${Δ V}_{1} ( electrode volume change rate during charging before active material ratio adjustment ) = 1.19$$

$${Δ V}_{2} ( electrode volume change rate during charging after active material ratio adjustment ) = 1.11$$

$$N / P ratio = 1.05$$

$$Maximum aperture ratio ( X ) = 4.76 \%$$

Based on this, the Δσ calculated according to the following equation was 0.56:

$$Δσ = \frac{{( T + 2 t )}^{2}}{{( T + 2 h )}^{2}} \times ( \frac{{Δ V}_{2} - X}{{Δ V}_{1}} )$$

That is, when adjusting the negative electrode active material ratio as in this example, it was confirmed that the bending stress acting on the electrode can be reduced by about 44%.

Meanwhile, this calculation assumes an electrode in the form of an ideal rectangular parallelepiped and calculates only the bending stress in the length direction, but there is also a reduction effect in other stresses such as stress in the width direction, shear stress, torsional stress, etc. In addition, there is an effect of alleviating localized stress concentration.

Embodiments of the present disclosure have been described above with reference to the drawings. These are exemplary in nature, and the present disclosure is not limited to the embodiments and the content of the drawings described above.

It will be apparent to those skilled in the art that modifications can be made to the present disclosure within the scope of the disclosed technical idea. The described embodiments should be considered as part of the present disclosure, but the scope of the present disclosure should not be defined solely by the described embodiments.

The scope of the present disclosure should be determined by the technical idea set forth in the claims. Further, in the description of the embodiments of the present disclosure, even if actions or effects according to the configuration are not explicitly described, actions or effects that can be predicted from the described configurations should also naturally be recognized as included in the present disclosure.

What is claimed is:

1. An electrode assembly comprising
a plurality of positive electrodes and a plurality of negative electrodes that are stacked,
wherein the negative electrodes comprise an outermost negative electrode portion disposed at an outermost part of the electrode assembly,
wherein the outermost negative electrode portion comprises:
a first negative electrode current collector;
a first negative electrode active material layer disposed on one surface of the first negative electrode current collector; and
a second negative electrode active material layer disposed on the other surface of the first negative electrode current collector,
wherein one or more of the first negative electrode current collector, the first negative electrode active material layer, and the second negative electrode active material layer includes at least one aperture.

2. The electrode assembly of claim 1, wherein the first negative electrode active material layer and the second negative electrode active material layer comprise different patterns.

3. The electrode assembly of claim 1, wherein
the first negative electrode active material layer is disposed at the outermost part of the electrode assembly,
the second negative electrode active material layer is disposed to face a positive electrode, and
the second negative electrode active material layer comprises at least one aperture.

4. The electrode assembly of claim 1, wherein the second negative electrode active material layer comprises at least one aperture, and
wherein a depth of the at least one aperture is less than a thickness of the second negative electrode active material layer.

5. The electrode assembly of claim 1, wherein the second negative electrode active material layer comprises at least one aperture, and
wherein a depth of the at least one aperture is equal to a thickness of the second negative electrode active material layer.

6. The electrode assembly of claim 1, wherein the first negative electrode current collector and the second negative electrode active material layer each comprise at least one aperture.

7. The electrode assembly of claim 1, wherein the first negative electrode current collector, the first negative electrode active material layer, and the second negative electrode active material layer each comprise at least one aperture.

8. The electrode assembly of claim 1, wherein an aperture ratio of the at least one aperture satisfies Equation 1
$$Maximum aperture ratio = 1 - \frac{1}{N / P ratio} \qquad [ Equation l ]$$
wherein the N/P ratio refers to a negative-electrode loading relative to a positive-electrode loading.

9. The electrode assembly of claim 1, wherein the second negative electrode active material layer comprises an edge region corresponding to about 10 to 30% of a total area of the second negative electrode active material, and
wherein an aperture ratio of the edge region is higher than an aperture ratio of a region other than the edge region.

10. The electrode assembly of claim 1, wherein the first negative electrode active material layer and the second negative electrode active material layer comprise different negative electrode active materials.

11. The electrode assembly of claim 1, wherein the first negative electrode active material layer and the second negative electrode active material layer comprise graphite and silicon as negative electrode active materials, and
wherein a mixing ratio of graphite and silicon in the first negative electrode active material layer is different from a mixing ratio of graphite and silicon in the second negative electrode active material layer.

12. The electrode assembly of claim 11, wherein a proportion of graphite in the first negative electrode active material layer is higher than a proportion of graphite in the second negative electrode active material layer.

13. The electrode assembly of claim 1, wherein the electrode assembly is in a jelly-roll shape.

14. A secondary battery comprising the electrode assembly of claim 1.

15. An electrode assembly comprising
a plurality of positive electrodes and a plurality of negative electrodes that are stacked,
wherein the negative electrodes comprise an outermost negative electrode portion disposed at an outermost part of the electrode assembly, the outermost negative electrode portion comprising:
a first negative electrode current collector;
a first negative electrode active material layer disposed on one surface of the first negative electrode current collector; and
a second negative electrode active material layer disposed on the other surface of the first negative electrode current collector,
wherein the second negative electrode active material layer is formed to partially cover the first negative electrode current collector, such that an uncovered region of the first negative electrode current collector extends along an edge portion of the outermost negative electrode portion.

16. The electrode assembly of claim 15, wherein the uncovered region in the portion corresponds to about 10 to 30% of a total area of the second negative electrode active material.

17. The electrode assembly of claim 15, wherein the second negative electrode active material layer includes a plurality of apertures having an aperture ratio of the at least one aperture satisfies Equation 1
$$Maximum aperture ratio = 1 - \frac{1}{N / P ratio} \qquad [ Equation l ]$$
wherein the N/P ratio refers to a negative-electrode loading relative to a positive-electrode loading.

18. The electrode assembly of claim 15, wherein the uncovered region of the first negative electrode current collector at the edge portion is configured such that, during winding or folding of the electrode assembly into a jelly-roll or z-folded structure, localized stress concentrations at the outermost region of the electrode assembly are mitigated.

19. The electrode assembly of claim 15, wherein the second negative electrode active material layer has an overall thickness that is less than a thickness of the first negative electrode active material layer.

20. The electrode assembly of claim 15, wherein the first negative electrode active material layer and the second negative electrode active material layer comprise different patterns.
